(19) United States
(12) Patent Application Publication
(10) Pub. No.: US 2024/0190028 A1
(43) Pub. Date: Jun. 13, 2024

(54) UTILITY KNIFE BLADE SLIDER WITH AUTO-LOCK ON BLADE INSERTION

(71) Applicant: Stanley Black & Decker, Inc., New Britain, CT (US)

(72) Inventors: Jasmine Trivedi, Charlotte, NC (US); Daniel Newman, Salem, VA (US); Thomas Marcincavage, Morven, NC (US)

(21) Appl. No.: 18/064,400

(22) Filed: Dec. 12, 2022

(51) Int. Cl. B26B 5/00

(52) U.S. Cl. CPC B26B 5/003; B26B 5/005

(57) ABSTRACT

A blade retainer includes a base portion and a locking arm. The base portion includes a side wall and a guide member. The side wall and the guide member form a boundary of a receiving channel for slidably receiving and removably retaining a blade. The locking arm includes an overhang portion on a first end of the locking arm and a retainer portion on the second end of the locking arm. The overhang portion is coupled to the base portion and extends across the receiving channel. The retainer portion removably engages a notch of the blade. During installation of the blade, a leading edge of the blade passes the overhang portion prior to contacting the retainer portion, the blade deflects the locking arm out of the receiving channel, and the locking arm resiliently returns to the receiving channel and the retainer portion engages the notch of the blade.

### FIELD

The present disclosure generally relates to utility knives and, more particularly, to utility knife blade sliders.

### BACKGROUND

A utility knife—also called a box cutter—is a common tool used in various trades and crafts for a variety of purposes. Utility knives may use fixed, folding, retractable, or replaceable blades and come in a wide variety of lengths and styles suited to the particular set of tasks they are designed to perform. For those utility knives with replaceable blades, the process for replacing or installing the blade often requires a moderate disassembly of the knife (e.g., a removal of a housing portion) or multiple motions or actions by the operator. For example, for blade installation, some utility knives require the operator to press a button while inserting the blade into a blade retainer. Other utility knives require the operator push the blade into a blade retainer, then slightly pull back on the blade to engage a locking feature. These complexities associated with installing a blade can be undesirable and are prone to error, which can result in an unsecured blade and potential injury.

### SUMMARY

The following disclosure describes non-limiting examples of some embodiments. For instance, other embodiments of the disclosed systems and methods may or may not include the features described herein. Moreover, disclosed advantages and benefits can apply only to certain cases of the inventive concept and should not be used to limit the disclosure. The embodiments disclosed herein each have several aspects, no single one of which is solely responsible for the disclosure's desirable attributes.

Some examples of the present inventive concept include a blade retainer. The blade retainer can include a base portion and a locking arm. The base portion can include a side wall and one or more guide members positioned on opposite ends of the side wall. The side wall and the one or more guide members can form a boundary of a receiving channel for slidably receiving and removably retaining a utility blade. The locking arm can include a first end and a second end opposite the first end. The locking arm can include an overhang portion on the first end and a retainer portion on the second end. The overhang portion can be coupled to the base portion and can extend across the receiving channel. The retainer portion can be configured to removably engage a notch of the utility blade. During installation of the utility blade into the blade retainer along the receiving channel, a leading edge of the utility blade passes the overhang portion prior to contacting the retainer portion, the utility blade deflects the locking arm out of the receiving channel, and the locking arm resiliently returns to the receiving channel and the retainer portion engages the notch of the utility blade.

Various enhancements, refinements, and other modifications may be made to the blade retainer of the preceding paragraph. For example, the locking arm can include an elongate member extending between the overhang portion and the retainer portion. The elongate member can be sloped such that the overhang portion and the retainer portion are different heights relative to the receiving channel. A longitudinal axis of the elongate member can be substantially parallel to a primary plane of the side wall. The elongate member can slope downward from the overhang portion to the retainer portion. The retainer portion can be positioned closer to receiving channel than the overhang portion. The overhang portion can extend across an upper edge of the receiving channel.

Various enhancements, refinements, and other modifications may be made to the blade retainer of any of the preceding paragraphs. For example, when not deflected by the utility blade, at least a portion of the locking arm can protrude into the receiving channel. A presence of the retainer portion in the notch can inhibit removal of the utility blade from the blade retainer. During the installation, the utility blade can shift the retainer portion in a first direction. The first direction can be substantially vertical. During the installation, the utility blade can shift the retainer portion in a second direction. The second direction can be substantially horizontal. During the installation, the utility blade can raise the retainer portion out of the receiving channel. The overhang portion can extend substantially perpendicular from a primary surface of the side wall.

Various enhancements, refinements, and other modifications may be made to the blade retainer of any of the preceding paragraphs. For example, the utility blade can have a generally flat, isosceles trapezoidal configuration defined by a cutting edge, a retaining edge opposite the cutting edge, and a pair of opposing side edges. The retaining edge can define the notch. One of the side edges can include the leading edge. The locking arm can be a leaf spring. The utility blade can be installable in the blade retainer without use of any user actuator button for manipulating the locking arm.

Various enhancements, refinements, and other modifications may be made to the blade retainer of any of the preceding paragraphs. For example, the blade retainer can define an entrance through which the utility blade may enter the receiving channel. The second end of the locking arm can be distal to the utility blade entrance relative to the first end of the locking arm. The leading edge of the utility blade can be inclined. Translational movement of the utility blade along the receiving channel can cause the retainer portion to contact and slide along the incline of the leading edge. The locking arm can be pivotably connected to the base portion. The first end can be a pivot end. The blade retainer can include a biasing member configured to bias the retainer portion in a direction towards the receiving channel. During the installation, the leading edge of the utility blade can contact the retainer portion and can pivot the locking arm about the pivot end in a direction away from the receiving channel.

Some examples of the present inventive concept include a blade retainer. The blade retainer can include a base portion and a locking arm. The base portion can include a side wall and one or more guide members positioned on opposite ends of the side wall. The side wall and the one or more guide members can form a boundary of a receiving channel for slidably receiving and removably retaining a utility blade. The locking arm can extend from the base portion. The locking arm can include an angled impacting surface configured to removably engage a notch of the utility blade. The angled impacting surface can be an exterior surface of an indention in the locking arm. During installation of the utility blade into the blade retainer along the receiving channel, a leading edge of the utility blade can contact the angled impacting surface and can deflect the locking arm out of the receiving channel. The locking arm can resiliently return to the receiving channel and the angled impacting surface can engage the notch of the utility blade.

Various enhancements, refinements, and other modifications may be made to the blade retainer of any of the preceding paragraphs. For example, the angled impacting surface can be part of a diamond-shaped depression in the locking arm. During the installation, the leading edge of the utility blade can contact the angled impacting surface of the locking arm prior to contacting any other surfaces of the locking arm. The angled impacting surface can be nonperpendicular to a primary surface of the side wall. The angled impacting surface can be nonparallel to the leading edge of the utility blade. The utility blade can have a generally flat, isosceles trapezoidal configuration defined by a cutting edge, a retaining edge opposite the cutting edge, and a pair of opposing side edges. The retaining edge can define the notch. One of the side edges can include the leading edge.

Various enhancements, refinements, and other modifications may be made to the blade retainer of any of the preceding paragraphs. For example, the utility blade can be installable in the blade retainer without use of any user actuator button for manipulating the locking arm. During the installation, the utility blade can shift the locking arm in a first direction. The first direction can be substantially vertical. During the installation, the utility blade can shift the locking arm in a second direction. The second direction can be substantially horizontal. In some cases, the angled impacting surface is not formed along a score line during manufacture.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 illustrates an example utility knife in accordance with the present disclosure.

FIG. 2A illustrates a first example of a blade retainer in accordance with the present disclosure.

FIG. 2B illustrates an example locking arm in accordance with the present disclosure.

FIGS. 3A-3C illustrate an example of a transitional sequence for installing a utility blade into the blade retainer of FIG. 2A.

FIG. 4 illustrates a second example of a blade retainer in accordance with the present disclosure.

FIGS. 5A-5C illustrate an example of a transitional sequence for installing the utility blade into the blade retainer of FIG. 4.

FIG. 5D illustrates a top view of the utility blade and blade retainer in the relative positions shown in FIG. 5B.

FIGS. 6A and 6B illustrate a third example of a blade retainer in accordance with the present disclosure.

FIGS. 7A-7C illustrate an example of a transitional sequence for installing the utility blade into the blade retainer of FIGS. 6A and 6B.

### DETAILED DESCRIPTION

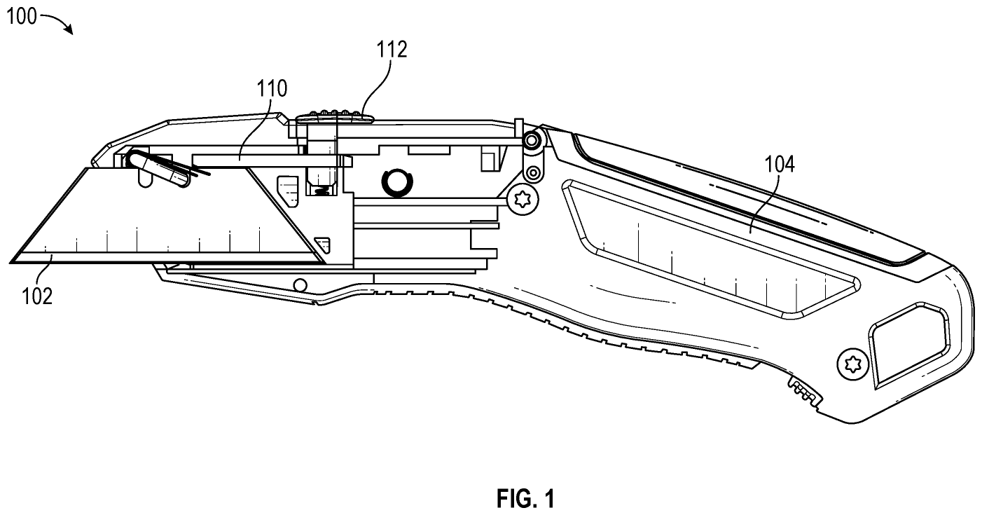

FIG. 1 illustrates an example utility knife 100 in accordance with the present disclosure. In this example, a portion of the housing 104 has been removed to increase visibility of components internal to the housing 104. The utility knife 100 includes a housing 104, a blade retainer 110, and a utility blade 102 secured at least partially within the housing 104 via the blade retainer 110. In this example, the utility blade 102 is retractable within the housing 104 via a slider portion 112 interconnected with the blade retainer 110. It will be appreciated that the inventive concepts described herein are compatible with any type of cutting instrument configured to removably receive a blade including, but not limited to, fixed, retractable, or folding knifes.

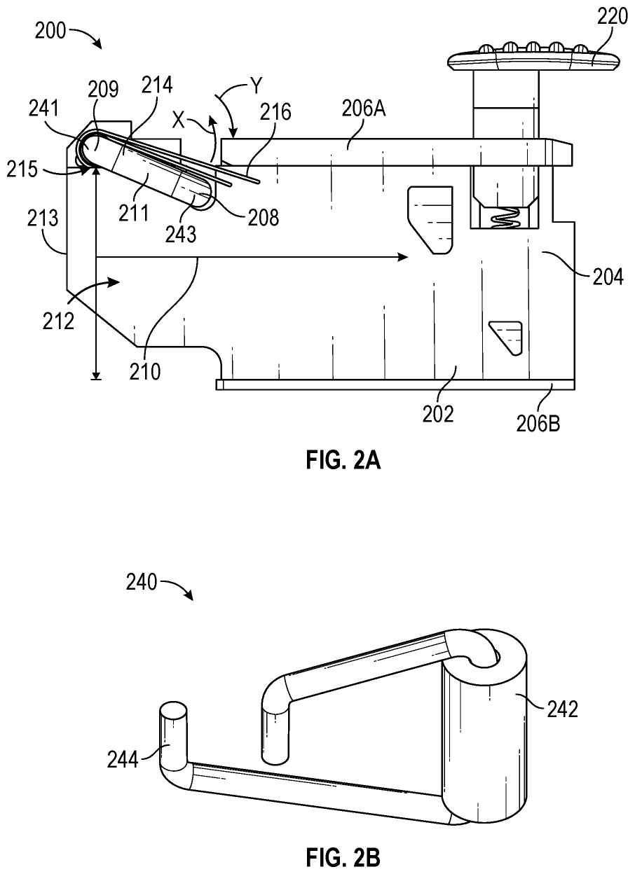

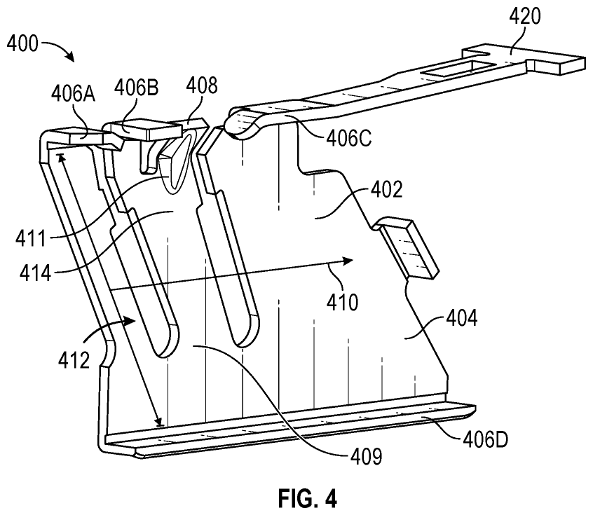

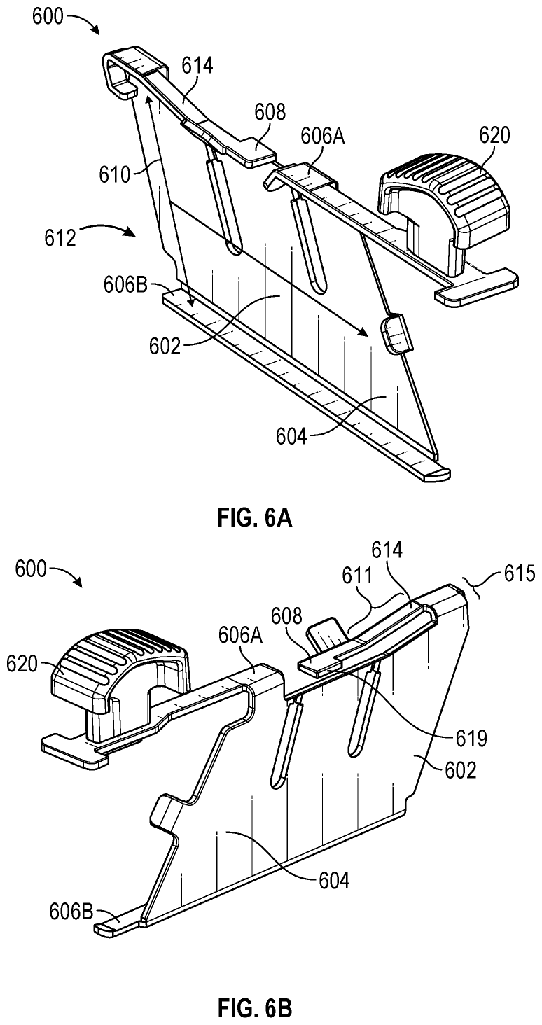

FIG. 2A illustrates a first example of a blade retainer 200 in accordance with the present disclosure. The blade retainer 200 includes a base portion 202, a side wall 204, one or more guide members 206A, 206B (individually or collectively referred to as guide members 206 or a guide member 206), a locking arm 214, a biasing member 216, and a slider portion 220. The blade retainer 200 is an example of the blade retainer 120 of FIG. 1 and may be compatible with, such as installable in, the utility knife 100 or other utility knives. It will be appreciated that the blade retainer 200 represents an example blade retainer and other examples may use fewer, additional, or different components or arrangements. For example, the blade retainer 200 may include any one or more of the features of the blade retainers 400 or 600 of FIGS. 4 and 6A, respectively.

The blade retainer 200 defines a receiving channel 212 for slidably receiving a utility blade through an entrance 213 in the blade retainer 200. The blade retainer 200 can removably retain the utility blade in the receiving channel 212. In some cases, a boundary of the receiving channel 212 is formed by the side wall 204 and the one or more guide members 206. For example, the guide members 206 can include one or more overhang, U-shaped, or T-shaped portions. In some cases, a cross sectional shape of the receiving channel 212 is complementary to cross sectional shape of the utility blade. Example dimensions for the receiving channel 212 are indicated by the line 210.

The locking arm 214 (sometimes referred to as a spring arm) includes a first end 241, a second end 243, and an elongate member 211. The first end 641 includes an overhang portion 215 and the second end 243 includes a retainer portion 208. The overhang portion 215 extends from the base portion 202, across an edge of the receiving channel 212. In some cases, the boundary of the receiving channel 212 is formed in part by the overhang portion 215. In some cases, the overhang portion 215 extends substantially perpendicular from a primary surface of the side wall 604.

The elongate member 211 extends from the overhang portion 215 to the retainer portion 208. In some cases, the elongate member is sloped such that the overhang portion 215 and the retainer portion 208 are different heights relative to the receiving channel. For example, the elongate member 211 may slope downward from the overhang portion 215 to the retainer portion 208. In this way, the retainer portion 208 can be positioned closer to receiving channel 212 than is the overhang portion 215.

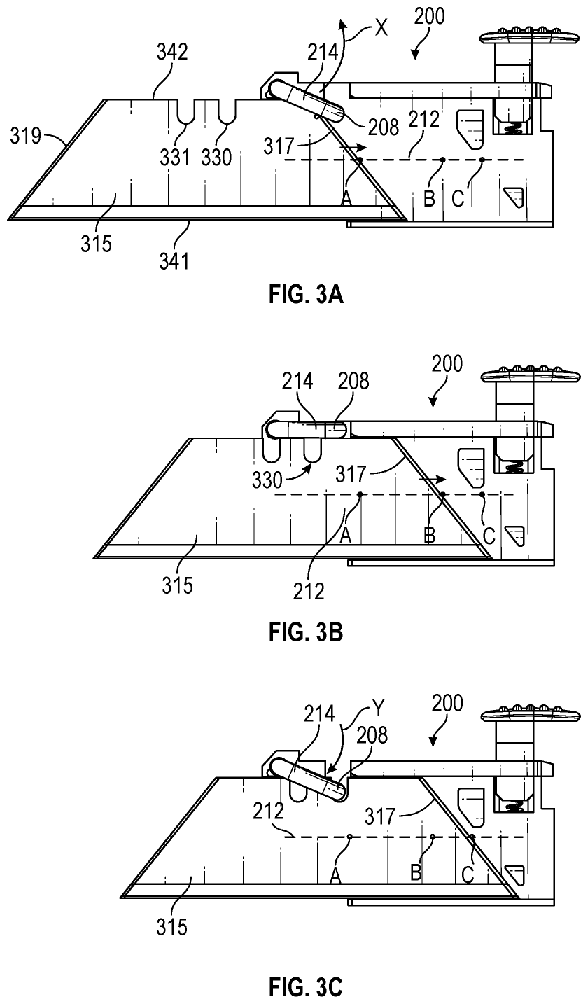

In this example, the locking arm 214 is pivotably connected to the blade retainer 200, such as to the base portion 202 or the guide member 206. The locking arm 214 includes a pivot portion 209 on the first end 241, about which the locking arm 214 may pivot, and a retainer portion 208 on the second end. The retainer portion 208 can be sized to engage (e.g., fit within) a notch of a utility blade (e.g., the notch 330 of utility blade 315 of FIG. 3A). By engaging with the notch of the utility blade, the retainer portion 208 secures the utility blade within the blade retainer 200. In the illustrated example of FIG. 2A, the pivot portion 209 is proximate the entrance 213 relative to the retainer portion 208. Furthermore, the pivot portion 209 is further away from the receiving channel (e.g., higher) than the retainer portion 208. In this way, during installation of a utility blade into the blade retainer 200, a leading edge (sometimes referred to as impacting edge) of the utility blade passes (e.g., under) the pivot portion 209 prior to contacting the retainer portion 208.

The biasing member 216 pivotally biases the retainer portion 208 in a first direction Y, which is a direction towards the receiving channel 212. In this way, absent other forces on the locking arm 214 (e.g., the utility blade is not present), the retainer portion 208 is located at least partially within the receiving channel 212. When the utility blade is inserted into the blade retainer 200, the utility blade deflects the retainer portion 208 out of the receiving channel 212 (e.g., pivoting the retainer portion 208 in a second direction X). Furthermore, when a notch of the utility blade aligns with the retainer portion 208, the biasing member 216 biases the retainer portion 208 into the notch, thereby securing the utility blade within the blade retainer 200.

The biasing member 216 can be implemented as a spring, such as a torsion spring. In addition or alternatively, the biasing member 216 can be implemented as any component made from elastic material that, when twisted or rotated, exerts a moment resisting the rotation. Although FIG. 2A illustrates the biasing member 216 as being separate from the locking arm 214, in some cases the locking arm 214 and the biasing member 216 are implemented as a single member. For example, FIG. 2B illustrates an example locking arm 240 as a carabiner-style locking arm that functions as both a locking arm and a biasing member. It will be appreciated that the locking arm 240 represents an embodiment of the locking arm 214 of FIG. 2A. For example, the locking arm 240 includes a retainer portion 242 and pivoting portion 244, which may be embodiments of the retainer portion 208 and the pivot portion 209 of FIG. 2A, respectively.

FIGS. 3A-3C illustrate an example of a transitional sequence for installing a utility blade 315 into the blade retainer 200 of FIG. 2A. In particular, FIGS. 3A-3C show the utility blade 315 sequentially transitioning from Point A to Point B to Point C along the receiving channel 212, indicated by the dashed line.

The utility blade 315 has a generally flat, isosceles trapezoidal configuration defined by a cutting edge 341, a retaining edge 342 (also referred to as an upper edge 342) opposite the cutting edge 341, and a pair of opposing first and second side edges 317, 319. The retaining edge 342 defines at least one notch 330, 331 for mating with a complementary retainer portion 208 provided on the blade retainer 200. The utility blade 315 may be reversible such that it may be receivable into the blade retainer 200 from the direction of either the first side edge 317 or the second side edge 319. For purposes of this disclosure, the particular side (e.g., the first side edge 317 or the second side edge 319) that is first inserted into the blade retainer 200 is referred to as the leading edge or the leading edge. In the illustrated example, the leading edge is the first side edge 317, since the first side edge 317 will contact the locking arm 214 when the utility blade 315 is installed into the blade retainer 200.

As shown in FIG. 3A, when the utility blade 315 is at Point A, a leading edge 317 of the utility blade 315 contacts the retainer portion 208 of the locking arm 214. As the utility blade 315 is translated along the receiving channel 212 from Point A to Point B, the leading edge 317 of the utility blade 315 imparts a force on the retainer portion 208 that opposes the bias force of the biasing member 216, thereby pivoting the locking arm 214 in the second direction X and out of the receiving channel 212. In this example, the leading edge 317 of the utility blade 315 is slanted or sloped such that the leading edge 317 is declined towards the locking arm 214. As a result, during the transition of the utility blade 315 from Point A to Point B, the retainer portion 208 acts as a cam follower by following along the declined surface of the leading edge 317, before following along the retaining edge 342 of the utility blade 315. In this example, the leading edge 317 of the utility blade is angled at about 45 degrees. However, it will be understood that the angle of the leading edge 317 may vary across embodiments.

As shown in FIG. 3B, when the utility blade 315 is at Point B, the retainer portion 208 of the locking arm 214 rests along the retaining edge 342 of the utility blade 315. As the utility blade 315 is translated along the receiving channel 212 from Point B to Point C, the retainer portion 208 follows along the retaining edge 342 of the utility blade 315 and, upon alignment of the retainer portion 208 and the notch 330 of the utility blade 315, the bias of the biasing member 216 causes the retainer portion 208 to return to the receiving channel 212 by moving (e.g., snapping down) into the notch 330 of the utility blade 315.

As shown in FIG. 3C, when the utility blade 315 is at Point C, the retainer portion 208 resides within the notch 330 of the utility blade 315. The presence of the retainer portion 208 in the notch 330 inhibits removal of the utility blade 315 from the blade retainer 200 and/or reduces wobble of the utility blade 315 during use.

In some cases, the manufacturing process for a utility blade and/or a blade retainer can involve shearing sheet metal or breaking hardened sheet metal along a score line. Either option can result in the edges of at least one face of the metal being rough. When the rough edge of the blade retainer faces the utility blade and the operator inserts the utility blade with the rough edge of the utility blade as the leading edge, these two rough edges can catch against one another and prevent smooth insertion of the utility blade into the blade retainer. When the rough edge of the locking arm faces the housing of the utility knife, the rough edge of the locking arm can drag on the housing, creating a poor user perception when sliding the blade retainer in and out of the knife housing.

To address these or other concerns, disclosed herein is a blade retainer that allows smooth insertion, regardless of the presence of rough edges on the utility blade and/or the blade retainer. In particular, the blade retainer disclosed herein includes an angled impacting surface (e.g., a crease in the sheet metal) for contacting a leading edge of the utility blade. By implementing an angled impacting surface that contacts the leading edge of the utility blade first, there may be no rough edges on the angled impacting surface, thereby reducing a likelihood of increased friction between it and the potentially rough edge of the utility blade.

FIG. 4 illustrates a second example of a blade retainer 400 in accordance with the present disclosure. The blade retainer 400 includes a base portion 402, a side wall 404, one or more guide members 406A, 406B, 406C, 406D (individually or collectively referred to as guide members 406 or a guide member 406), a locking arm 414 having an angled impacting surface 411, and a slider portion 420. The blade retainer 400 is an example of the blade retainer 120 of FIG. 1 and may be compatible with, such as installable in, the utility knife 100 or other utility knives. It will be appreciated that the blade retainer 400 represents an example blade retainer and other examples may use fewer, additional, or different components or arrangements. For example, the blade retainer 400 may include any one or more of the features of the blade retainers 200 or 600 of FIGS. 2A and 6A, respectively.

The blade retainer 400 defines a receiving channel 412 for slidably receiving a utility blade through an entrance 413 in the blade retainer 400. The blade retainer 400 can removably retain the utility blade in the receiving channel 412. In some cases, a boundary of the receiving channel 412 is formed by the side wall 404 and the one or more guide members 406. For example, the guide members 406 can include one or more overhang, U-shaped, or T-shaped portions. In some cases, a cross sectional shape of the receiving channel 412 is complementary to a cross sectional shape of the utility blade. Example dimensions for the receiving channel 412 are indicated by the line 410. In some cases, a cross sectional shape of the receiving channel 412 is complementary to a cross sectional shape of the utility blade.

The locking arm 414 may be unitarily formed with the base portion 402. In some cases, the locking arm 414 is implemented as a flexure bearing, such as living hinge or a leaf spring. The locking arm 414 includes a first end 409 coupled to the base portion 402 and a second end 408 (sometimes referred to as a retainer portion 408). The retainer portion 408 includes an angled impacting surface 411 for contacting a leading edge 317 of the utility blade 315. As described herein, in some cases, the angled impacting surface 411 is not formed along a score line and therefore has no rough edges that might introduce friction. The angled impacting surface 411 may be any raised geometry, such as a crease, an indent, a bend, or stamped portion on or near the retainer portion 408. In some cases, the angled impacting surface 411 is the first (and, in some cases, the only) surface of the locking arm 414 that is contacted by the leading edge 317 of the utility blade 315 during installation. In some cases, the angled impacting surface 411 is implemented as a diamond-shaped depression in the retainer portion 408.

The retainer portion 408 and/or the angled impacting surface 411 can be sized to engage (e.g., fit within) a notch 330 of the utility blade 315. By engaging with the notch 330 of the utility blade, the retainer portion 408 secures the utility blade 315 within the blade retainer 400.

The locking arm 414 protrudes from and/or may be considered part of the base portion 402 and/or the side wall 404. The locking arm 414 is moveable between a nondeflected state and a deflected state through elastic body deformation. In a nondeflected state (i.e., a normal resting state), at least a portion of the retainer portion 408 (e.g., the angled impacting surface 411) protrudes at least partially into the receiving channel 412. In this way, the utility blade 315 contacts the retainer portion 408 during installation of the utility blade 315 into the blade retainer 400. The locking arm 114 is in a deflected state when it is not in a nondeflected state. As such, the deflected state may include any of a plurality of orientations of the locking arm 114. As described herein, during installation of the utility blade 315 into the blade retainer 400, the utility blade 315 deflects the locking arm 414 away from the utility blade 315 until the utility blade 315 moves into a position in which the notch 330 is aligned with the retainer portion 408. When the notch 330 is aligned with the retainer portion 408, the retainer portion 408 snaps into and engages with the notch 330.

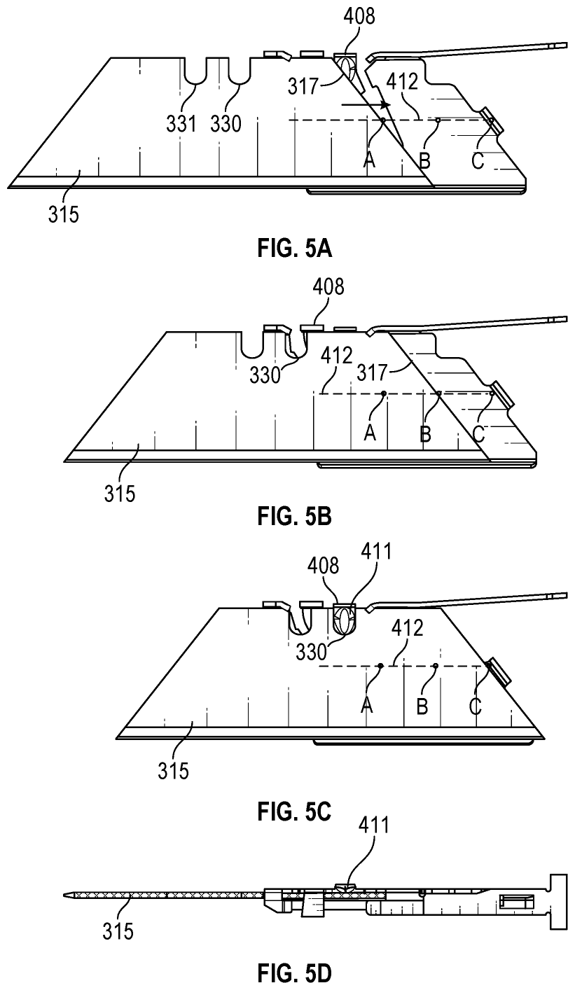

FIGS. 5A-5C illustrate an example of a transitional sequence for installing the utility blade 315 into the blade retainer 400 of FIG. 4. In particular, FIGS. 5A-5C show the utility blade 315 sequentially transitioning from Point A to Point B to Point C along the receiving channel 412, indicated by the dashed line.

As shown in FIG. 5A, when the utility blade 315 is at Point A, a leading edge 317 of the utility blade 315 contacts the angled impacting surface 411 of the locking arm 414. As the utility blade 315 is translated along the receiving channel 412 from Point A to Point B, the leading edge 317 of the utility blade 315 deflects the angled impacting surface 411 (and thus the retainer portion 408) out of the receiving channel 412 and moves the locking arm 414 into a deflected state. In this example, the angled impacting surface 411 is declined towards the entrance 413. As a result, during the transition of the utility blade 315 from Point A to Point B, the retainer portion 408 acts as a cam follower by following along the leading edge 317 of the utility blade, before following along a back surface of the utility blade 315.

As shown in FIG. 5B, when the utility blade 315 is at Point B, the retainer portion 408 of the locking arm 414 rests along a back surface (not shown) of the utility blade 315. As the utility blade 315 is translated along the receiving channel 412 from Point B to Point C, the retainer portion 408 follows along the back surface of the utility blade 315.

FIG. 5D illustrates a top view of the utility blade 315 and blade retainer 400 in the positions shown in FIG. 5B. As shown, in the deflected state, and while the retainer portion 408 follows along the back surface of the utility blade 315, the retainer portion 408 pushed back, away from the utility blade 315.

As shown in FIG. 5C, upon alignment of the retainer portion 408 and the notch 330 of the utility blade 315, the locking arm 414 returns to a nondeflected state through elastic body deformation. In returning to the nondeflected state, the retainer portion 408 moves (e.g., snaps forward towards the utility blade) into the notch 330 of the utility blade 315. The presence of the retainer portion 408 in the notch 330 inhibits removal of the utility blade 315 from the blade retainer 400 and/or reduces wobble of the utility blade 315 during use.

FIGS. 6A and 6B illustrate a third example of a blade retainer 600 in accordance with the present disclosure. The blade retainer 600 includes a base portion 602, a side wall 604, one or more guide members 606A, 606B (individually or collectively referred to as guide members 606 or a guide member 606), a locking arm 614, and a slider portion 620. The blade retainer 600 is an example of the blade retainer 120 of FIG. 1 and may be compatible with, such as installable in, the utility knife 100 or other utility knives. It will be appreciated that the blade retainer 600 represents an example blade retainer and other examples may use fewer, additional, or different components or arrangements. For example, the blade retainer 600 may include any one or more of the features of the blade retainers 200 or 400 of FIGS. 2A and 4, respectively.

The blade retainer 600 defines a receiving channel 612 for slidably receiving a utility blade through an entrance 613 in the blade retainer 600. The blade retainer 600 can removably retain the utility blade 315 in the receiving channel 612. In some cases, a boundary of the receiving channel 612 is formed by the side wall 604 and the one or more guide members 606. For example, the guide members 606 can include one or more overhang, U-shaped, or T-shaped portions. In some cases, a cross sectional shape of the receiving channel 612 is complementary to a cross sectional shape of the utility blade. Example dimensions for the receiving channel 612 are indicated by the line 610. In some cases, a cross sectional shape of the receiving channel 612 is complementary to a cross sectional shape of the utility blade 315.

In some cases, the presence of one or more slots in the side wall 604 can reduce a likelihood of warpage during heat-treat or deformation of the blade retainer 600, such as during shipment. Although the side wall 604 is illustrated as defining two slots therein, it will be appreciated that the number of slots may vary across embodiments. For example, in some cases, the side wall 604 may include one slot or more than two slots. In some cases, the configuration of the locking arm 614 (e.g., extending from the front of the blade retainer 600, towards the rear) can reduce the negative effect of warpage during heat-treat or deformation of the blade retainer 600. To that end, in some cases, slots may be superfluous and thus the side wall 604 may include no slots therein.

The locking arm 614 may be unitarily formed with the base portion 602 and/or one or more guide members 606. In some cases, the locking arm 614 is implemented as a flexure bearing, such as living hinge or a leaf spring.

The locking arm 614 includes a first end 641, a second end 643, and an elongate member 611. The first end 641 includes an overhang portion 615 and the second end 643 includes a retainer portion 608. The overhang portion 615 extends from the base portion 602, across an edge of the receiving channel 612. In some cases, the boundary of the receiving channel 612 is formed in part by the overhang portion 615. In some cases, the overhang portion 615 extends substantially perpendicular from a primary surface of the side wall 604.

The elongate member 611 extends from the overhang portion 615 to the retainer portion 608. In some cases, the elongate member is sloped such that the overhang portion 615 and the retainer portion 608 are different heights relative to the receiving channel. For example, the elongate member 611 may slope downward from the overhang portion 615 to the retainer portion 608. In this way, the retainer portion 608 can be positioned closer to receiving channel 612 than is the overhang portion 615. In some cases, the elongate member 611 is sloped downward such that a leading edge of a utility blade contacts a back surface (not shown) of the elongate member 611 during installation of the utility blade 315. In some cases, the elongate member 611 is the first (and, in some cases, the only) surface of the locking arm 614 that is contacted by the leading edge of the utility blade during installation. In some cases, a longitudinal axis of the elongate member 611 can be substantially parallel to a primary plane of the side wall 604.

The retainer portion 608 includes a retainer portion 619 sized for engagement with a notch of the utility blade 315. By engaging with the notch of the utility blade, the retainer portion 608 secures the utility blade 315 within the blade retainer 600. It will be appreciated that the length, width, curvature, bend, and/or angle of the overhang portion 615, the elongate member 611, and/or the retainer portion 608 can vary across embodiments. For example, in some cases, the overhang portion 337 forms an arch or bridge shape.

The locking arm 614 is moveable between a nondeflected state and a deflected state through elastic body deformation. In a nondeflected state (i.e., a normal resting state), at least a portion of the elongate member 611 protrudes at least partially into the receiving channel 612. In this way, the utility blade contacts the elongate member 611 during installation of the utility blade into the blade retainer 600. The locking arm 114 is in a deflected state when it is not in a nondeflected state. As such, the deflected state may include any of a plurality of orientations of the locking arm 114. As described herein, during installation of the utility blade into the blade retainer 600, the utility blade deflects the locking arm 614 away from (e.g., above) the utility blade, until the notch of the utility blade is aligned with the retainer portion 608.

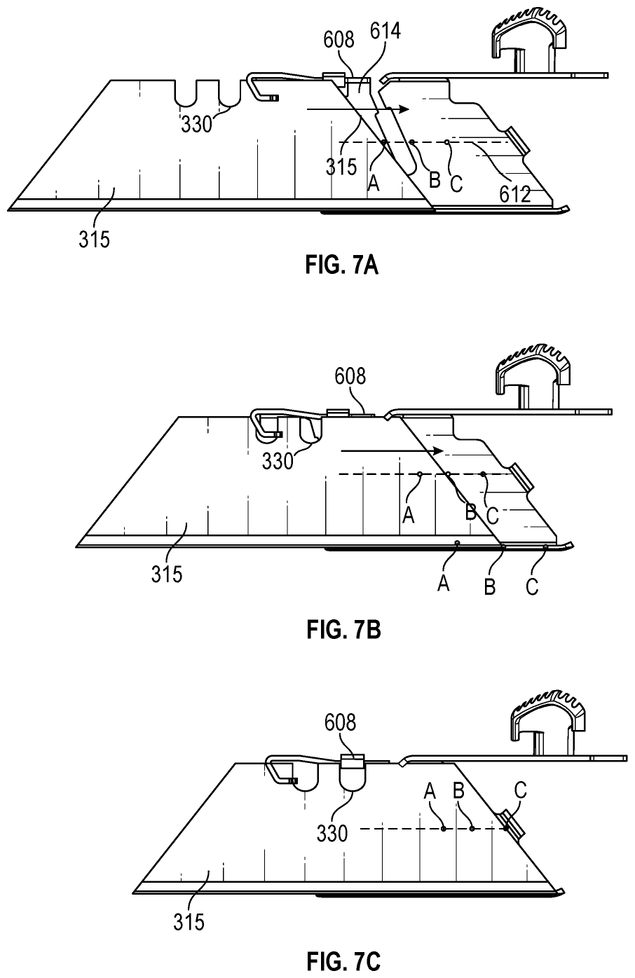

FIGS. 7A-7C illustrate an example of a transitional sequence for installing the utility blade 315 into the blade retainer 600 of FIGS. 6A and 6B. In particular, FIGS. 7A-7C show the utility blade 315 sequentially transitioning from Point A to Point B to Point C along the receiving channel 612, indicated by the dashed line.

As shown in FIG. 7A, when the utility blade 315 is at Point A, a leading edge 317 of the utility blade 315 contacts the elongate member 611 of the locking arm 614. As the utility blade 315 is translated along the receiving channel 612 from Point A to Point B, the leading edge 317 of the utility blade 315 deflects the elongate member 611 (and thus the retainer portion 608) out of the receiving channel 612 and moves the locking arm 614 into a deflected state. In this example, the elongate member 611 is declined away from the entrance 613. As a result, during the transition of the utility blade 315 from Point A to Point B, the leading edge 317 follows along the elongate member 611, raising the retainer portion 608 out of the receiving channel 612.

As shown in FIG. 7B, when the utility blade 315 is at Point B, the retainer portion 608 of the locking arm 614 rests along a retaining edge 342 of the utility blade 315. As the utility blade 315 is translated along the receiving channel 612 from Point B to Point C, the retainer portion 608 follows along the top surface of the utility blade 315.

As shown in FIG. 7C, upon alignment of the retainer portion 608 and the notch 330 of the utility blade 315, the locking arm 614 returns to a nondeflected state through elastic body deformation. In returning to the nondeflected state, the retainer portion 608 moves (e.g., snaps down) into the notch 330 of the utility blade 315. The presence of the retainer portion 608 in the notch 330 inhibits removal of the utility blade 315 from the blade retainer 600 and/or reduces wobble of the utility blade 315 during use.

As shown by the example transitional sequences of FIGS. 3A-3C, 5A-5C, and 7A-5C an operator may easily install a utility blade in a blade retainer designed in accordance with the present disclosure. In particular, the operator can install the utility blade in the blade retainer by inserting the utility blade into an opening of the blade retainer and pushing the utility blade into the blade retainer. In some cases, this sequence is referred to a single action or single movement, since it does not require the operator to make perform additional, other actions to secure the utility blade within the blade retainer. That is, the blade retainer may not require the operator to press a user actuator button (e.g., release lever or button) to permit or finalize installation of the utility blade. Furthermore, the blade retainer may not require the operator to “pull back” on the blade to snap a locking mechanism into place. Rather, the blade retainer automatically secures the utility blade as a result of the pushing force imparted by the operator on the utility blade.

In some cases, the sequence for removal of the utility blade from a blade retainer may diverge from the sequence for installation. For example, to remove the utility blade 315, the operator may be required to activate an actuator portion (e.g., an unlocking lever) to disengage (e.g., lift, move aside) the retainer portion 208 from the notch 330 and permit translational removal of the utility blade 315 from the blade retainer 200.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

These and other changes can be made to the inventive concept in light of the above Detailed Description. While the above description describes certain examples of the inventive concept, and describes the best mode contemplated, no matter how detailed the above appears in text, the inventive concept can be practiced in many ways. Details of the system may vary considerably in its specific implementation, while still being encompassed by the inventive concept disclosed herein. As noted above, particular terminology used when describing certain features or aspects of the inventive concept should not be taken to imply that the terminology is being redefined herein to be restricted to any specific characteristics, features, or aspects of the inventive concept with which that terminology is associated. In general, the terms used in the following claims should not be construed to limit the inventive concept to the specific examples disclosed in the specification, unless the above Detailed Description section explicitly defines such terms. Accordingly, the actual scope of the inventive concept encompasses not only the disclosed examples, but also all equivalent ways of practicing or implementing the inventive concept under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

What is claimed is:

1. A blade retainer comprising:
a base portion comprising a side wall and one or more guide members positioned on opposite ends of the side wall, wherein the side wall and the one or more guide members form a boundary of a receiving channel for slidably receiving and removably retaining a utility blade; and
a locking arm having a first end and a second end opposite the first end, the locking arm comprising an overhang portion on the first end and a retainer portion on the second end, the overhang portion coupled to the base portion and extending across the receiving channel, the retainer portion configured to removably engage a notch of the utility blade,
wherein during installation of the utility blade into the blade retainer along the receiving channel:
a leading edge of the utility blade passes the overhang portion prior to contacting the retainer portion,
the utility blade deflects the locking arm out of the receiving channel, and
the locking arm resiliently returns to the receiving channel and the retainer portion engages the notch of the utility blade.

2. The blade retainer of claim 1, wherein the locking arm further comprises an elongate member extending between the overhang portion and the retainer portion, wherein the elongate member is sloped such that the overhang portion and the retainer portion are different heights relative to the receiving channel.

3. The blade retainer of claim 2, wherein a longitudinal axis of the elongate member is substantially parallel to a primary plane of the side wall.

4. The blade retainer of claim 2, wherein the elongate member slopes downward from the overhang portion to the retainer portion, and wherein the retainer portion is positioned closer to receiving channel than the overhang portion.

5. The blade retainer of claim 1, wherein the overhang portion extends across an upper edge of the receiving channel.

6. The blade retainer of claim 1, wherein when not deflected by the utility blade, at least a portion of the locking arm protrudes into the receiving channel.

7. The blade retainer of claim 1, wherein a presence of the retainer portion in the notch inhibits removal of the utility blade from the blade retainer.

8. The blade retainer of claim 1, wherein during the installation, the utility blade shifts the retainer portion in a first direction, wherein the first direction is substantially vertical.

9. The blade retainer of claim 1, wherein during the installation, the utility blade shifts the retainer portion in a second direction, wherein the second direction is substantially horizontal.

10. The blade retainer of claim 1, wherein during the installation, the utility blade raises the retainer portion out of the receiving channel.

11. The blade retainer of claim 1, wherein the overhang portion extends substantially perpendicular from a primary surface of the side wall.

12. The blade retainer of claim 1, wherein the utility blade has a generally flat, isosceles trapezoidal configuration defined by a cutting edge, a retaining edge opposite the cutting edge, and a pair of opposing side edges, wherein the retaining edge defines the notch, and wherein one of the side edges comprises the leading edge.

13. The blade retainer of claim 1, wherein the locking arm is a leaf spring.

14. The blade retainer of claim 1, wherein the utility blade is installable in the blade retainer without use of any user actuator button for manipulating the locking arm.

15. The blade retainer of claim 1, wherein the blade retainer defines an entrance through which the utility blade may enter the receiving channel, and wherein the second end of the locking arm is distal to the utility blade entrance relative to the first end of the locking arm.

16. The blade retainer of claim 1, wherein the leading edge of the utility blade is inclined, and wherein translational movement of the utility blade along the receiving channel causes the retainer portion to contact and slide along the incline of the leading edge.

17. The blade retainer of claim 1, wherein the locking arm is pivotably connected to the base portion, and wherein the first end is a pivot end.

18. The blade retainer of claim 1, further comprising a biasing member configured to bias the retainer portion in a direction towards the receiving channel.

19. The blade retainer of claim 17, wherein during the installation, the leading edge of the utility blade contacts the retainer portion and pivots the locking arm about the pivot end in a direction away from the receiving channel.

20. A blade retainer comprising:
a base portion comprising a side wall and one or more guide members positioned on opposite ends of the side wall, wherein the side wall and the one or more guide members form a boundary of a receiving channel for slidably receiving and removably retaining a utility blade; and
a locking arm extending from the base portion, the locking arm comprising an angled impacting surface configured to removably engage a notch of the utility blade, wherein the angled impacting surface is an exterior surface of an indention in the locking arm,
wherein during installation of the utility blade into the blade retainer along the receiving channel a leading edge of the utility blade contacts the angled impacting surface and deflects the locking arm out of the receiving channel, wherein the locking arm resiliently returns to the receiving channel and the angled impacting surface engages the notch of the utility blade.
